(19) United States
(12) Patent Application Publication
(10) Pub. No.: US 2010/0088420 A1
(43) Pub. Date: Apr. 8, 2010

(54) DATA PROCESSING DEVICE, PARTICULARLY A SET-TOP BOX FOR CONNECTION TO A RECEIVER, INPUT DEVICE FOR THE CONTROL OF A DATA PROCESSING DEVICE, AND METHOD FOR OPERATING A DATA PROCESSING DEVICE

(76) Inventor: Jens Glufke, Eglharting (DE)

Correspondence Address: STAAS & HALSEY LLP, SUITE 700, 1201 NEW YORK AVENUE, N.W., WASHINGTON, DC, 20005, US

(21) Appl. No.: 12/451,329

(22) PCT Filed: Apr. 22, 2008
(86) PCT No.: PCT/EP2008/054840

§ 371 Date: Nov. 6, 2009

(30) Foreign Application Priority Data
May 8, 2007 (EP) EP07009252

(51) Int. Cl. G06F 15/16

(52) U.S. Cl. 709/228

(57) ABSTRACT

A data processing device, particularly a set-top box, is connected to a receiver and a communication network from which it receives data, including content data and at least one item of identification data. The data processing device processes the data and transmits the processed data to the receiver for the output thereof. The data processing device is further configured to receive and process a code sent by an input device of the data processing device and/or of the receiver, the code being associated with an item of the identification data. In response to the receipt of the code, a communication connection is established between the data processing device, or a communication terminal, and a unit of the communication network, which is associated with the item of the identification data.

### CROSS REFERENCE TO RELATED APPLICATIONS

This application is the U.S. national stage of International Application No. PCT/EP2008/054840, filed Apr. 22, 2008 and claims the benefit thereof. The international application claims the benefits of European Application No. 07009252 filed on May 8, 2007; both applications are incorporated by reference herein in their entirety.

### BACKGROUND

Described below is a data processing device, particularly a set-top box, for connection to a receiver and to a communication network. Also described is an input apparatus, particularly a remote control, for controlling the data processing device, a method for operating the data processing device and a method for providing an interaction channel in a television program.

A plurality of television programs are currently broadcast with which it is necessary or possible for the viewers of the television program to contact the provider or producer of the television program using a communication terminal, e.g. a telephone. Contact is made for example to purchase goods offered in the program. Contact can also be made to cast a vote in a television program poll. Programs in which viewers can take part in a draw or competition are also popular.

To allow contact to be made with the program provider or the producer of the program, one or more telephone numbers are currently superimposed on the television picture. The television picture shown by a receiver visualizes the telephone number or telephone numbers, enabling the viewer to select the or one of the superimposed telephone number(s) using their communication terminal. This then sets up a communication connection to the program provider or producer. When the communication connection is set up, the viewer can purchase goods offered on a television program or take part in a poll or competition.

### SUMMARY

An aspect is to provide an option for simplifying participation in such television programs for viewers, in particular to specify a data processing device, particularly a set-top box, which facilitates making contact by setting up a communication connection to a program provider or program producer for a viewer. An input apparatus is also to be specified, which assists contact making by setting up a communication connection. A further aspect is to operate a method, to specify a data processing device, particularly a set-top box, which facilitates contact making by setting up a communication connection to the program producer or provider. Finally a method is to be specified, which allows an interaction channel to be provided in a television program.

A data processing device, particularly a set-top box, is provided for connection to a receiver, e.g. a television, and a communication network. The data processing device is configured to receive and process data sent from the communication network, including content data and at least one identification data item, and to transmit the processed data to the receiver to be output. The communication network is based for example on the internet protocol and allows the transmission not only of content data to the receiver but also of data that can be evaluated by the data processing device, i.e. the at least one identification data item. Use of the internet protocol also allows data to be sent back to the communication network. The content data may be perceptible, of a visual nature and is represented in a visible manner on the receiver. The at least one identification data item can represent a telephone number or another contact address for example, with the at least one identification data item being overlaid visibly on the content data. The data processing device is also configured to receive and process a code sent from an input apparatus of the data processing device and/or the receiver, which is associated with a certain identification data item of the identification data. The data processing device is configured, in response to receipt of the code, to set up a communication connection between the data processing device or a communication terminal and a facility of the communication network, with which the certain identification data item is associated.

To control the data processing device, an input apparatus, particularly a remote control, includes at least one input element, the input apparatus being configured to monitor an actuation of the at least one input element and, in response to the actuation of one of the input element, to send a unique code associated with the relevant input element, thereby initiating the setting up of a communication connection to a facility of a communication network, with which an identification data item associated with the code is associated.

In a method for operating a data processing device, particularly a set-top box, which is connected to a communication network and a receiver, data sent from a communication network, including content data and at least one identification data item, is received and processed and the processed data is transmitted to the receiver to be output. If a code sent from an input apparatus of the data processing device and/or of the receiver, which is associated with a certain identification data item of the identification data, is received, this data is processed and in response to receipt of the code a communication connection is established between the data processing device or a communication terminal and a facility of the communication network, with which the identification data item is associated.

A method for providing an interaction channel in a television program includes providing data to be output on a receiver, the data including not only content data but also at least one identification data item and respective selection information associated with the at least one identification data item. The data is transmitted to a data processing device for processing and forwarding to the receiver, which is connected to the data processing device and transmitting the at least one identification data item and the respective selection information associated with the identification data item to a communication unit in a communication network. A communication connection is established when the communication unit receives a message sent from the data processing device, from which a certain identification data item from the identification data can be determined, the communication connection being established between a facility, with which the certain identification data item is associated, and a communication terminal of a viewer.

The method provides a viewer of a television program with the option, by simple actuation of an input element of an input apparatus of the data processing device or of the receiver connected to the data processing device, of establishing a communication connection to a facility, with which the identification data item contained in the data is associated. As a result the viewer advantageously does not have to carry out the relatively complex procedure of inputting an identification data item shown on the receiver manually using a further communication terminal.

The method also has the advantage here that the existing method of simple superimposition of identification data onto the television program data is still possible, with the data not being received by way of a data processing device having a backward channel, such as internet protocol television (IPTV) for example.

According to one embodiment, the data processing device is also configured to determine the at least one identification data item and selection information corresponding to an input element of the input apparatus and associated with an identification data item respectively from the data sent from the communication network, it being possible for the data processing device to determine a respective code associated with the identification data from the selection information. The selection information is of a visual nature, being for example part of the content data or being overlaid on the content data and shown on the terminal. The selection information can represent color or key information of the input apparatus associated with the at least one identification data item. This shows the viewer that to make contact with the facility of the communication network, with which the certain identification data item is associated, it is only necessary for example to actuate a key (input element) associated with the selection information.

According to one development the at least one identification data item and the associated selection information are transmitted to the receiver to be output.

In another development the code is associated with the input element of the input apparatus and is sent by this on actuation of the input element.

To establish a communication connection between the data processing device or a communication terminal (of the viewer) and the facility of the communication network, with which the certain identification data item is associated, the data processing device stores the identification data item and the code associated with the identification data item.

According to one development the data processing device has a communication apparatus, by which a communication connection can be established directly to the facility of the communication network. The communication apparatus can be configured in the form of hardware or even software here.

Alternatively, to establish a connection to the facility of the communication network, the data processing device is configured to transmit a message to a communication unit of the communication network, including an identifier of the data processing device; information concerning the data transmitted to the receiver; information concerning the selection information or the identification data item, which is associated with the selection information, so that a communication unit of the communication network can establish a communication connection to the facility of the communication network. With this variant the data processing device supplies information to a communication unit of the communication network, based on which the communication unit can establish the communication connection and an association with the data processing device is possible. This is necessary for example for participation in a vote or competition. Association is also relevant when there is a charge for setting up the communication connection.

The data processing device is configured to receive data based on the internet protocol.

According to a further embodiment the data processing device only sets up a communication connection to the facility of the communication network when the code is received, if the data sent from the communication network and received by the data processing device, including the at least one identification data item and the respectively associated selection information, is transmitted to the receiver. This is intended to ensure that a communication connection can only be set up at the time of transmission of the television program. A content-based relationship is established between the setting up of the communication connection and the transmission of the television program.

In one embodiment of the method for operating the data processing device, the data processing device determines the at least one identification data item and selection information corresponding to an input element of the input apparatus and associated with an identification data item respectively from the data sent from the communication network. As described above, the selection information is of a visual nature, being part of the content data or being overlaid on the content data for example. The selection information allows the viewer to actuate an input element of the input apparatus, which corresponds to a certain identification data item of the identification data.

According to a further embodiment the data processing device determines a respective code associated with the identification data from the selection information.

According to a further embodiment, the at least one identification data item and the respectively associated selection information are stored in the data processing device. This allows the data processing device, on receipt of the code sent from the input apparatus and associated with an identification data item, to determine the relevant identification data item based on the selection information and to set up a communication connection.

According to a further embodiment of the method the data processing device establishes a communication connection directly with the facility of the communication network.

According to another embodiment, an identifier of the data processing device, information relating to the data transmitted to the receiver (e.g. to identify the program just being shown) and information relating to the selection information or the identification data item associated with the selection information is transmitted so that the communication unit of the communication network can establish a communication connection with the facility of the communication network.

According to a further embodiment the data is transmitted from the communication network to the data processing device according to the internet protocol.

### BRIEF DESCRIPTION OF THE DRAWINGS

These and other aspects and advantages will become more apparent and readily appreciated from the following description of the exemplary embodiments, taken in conjunction with the accompanying drawings of which:

FIG. 1 is a simplified screenshot providing an exemplary representation of a superimposition of telephone numbers in a television program, selection information for an input apparatus being associated respectively with the telephone numbers, and

FIG. 2 is a pictorial block diagram providing a schematic representation illustrating the sequence of the method.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The following terms are used in the context of the description below, their definitions being as follows:
IPTV: Internet protocol television.
IPTV provider: Internet protocol television provider.
Program provider: a facility, which supplies television programs to an IPTV provider.
Set-top box: receiver hardware, allowing the receipt of IPTV and connected to a receiver of the viewer. The set-top box contains appropriate software, supplied by the IPTV provider.
Backend: Computer and software infrastructure provided by the IPTV provider.
IPTV middleware: Software running in the IPTV provider backend, which manages the IPTV functionality.

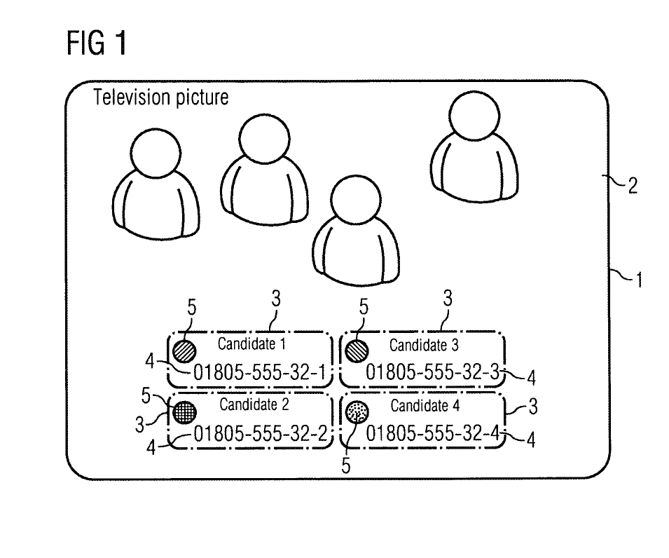

FIG. 1 shows a television picture 1, shown on a receive and play-back device, e.g. a television. Content data 2, symbolized by four people or candidates, is visualized in the television picture 1, being supplemented in the present exemplary embodiment by identification data of four candidates. The identification data 3 includes a specific telephone number 4 for each candidate respectively. A viewer watching the program shown on the receiver is to vote for one of the four candidates in the exemplary embodiment. The vote takes place via the selection of the telephone numbers 4, which are superimposed on the television picture and are for example chargeable. Additional information specified includes for example color codings 5 of input element of an input apparatus in the form of a remote control of a data processing device, referred to below as keys. The color codings are part of respective identification data 3. The data processing device is a set-top box, which is connected on the one hand to the receiver and on the other hand to a communication network operating according to the internet protocol, in order to process the data sent by way of the communication network and convert it to a data format that can be understood by the receiver.

The color codings 5 shown in the television picture, which are associated with a respective telephone number 4, thus correspond to keys on the remote control of the IPTV set-top box or the receiver connected to the IPTV set-top box. Instead of using color keys, it is of course also possible to allocate any other keys on the remote control to a respective telephone number. The use of color keys is standard for user guidance generally and is therefore easily understood by a viewer and operator.

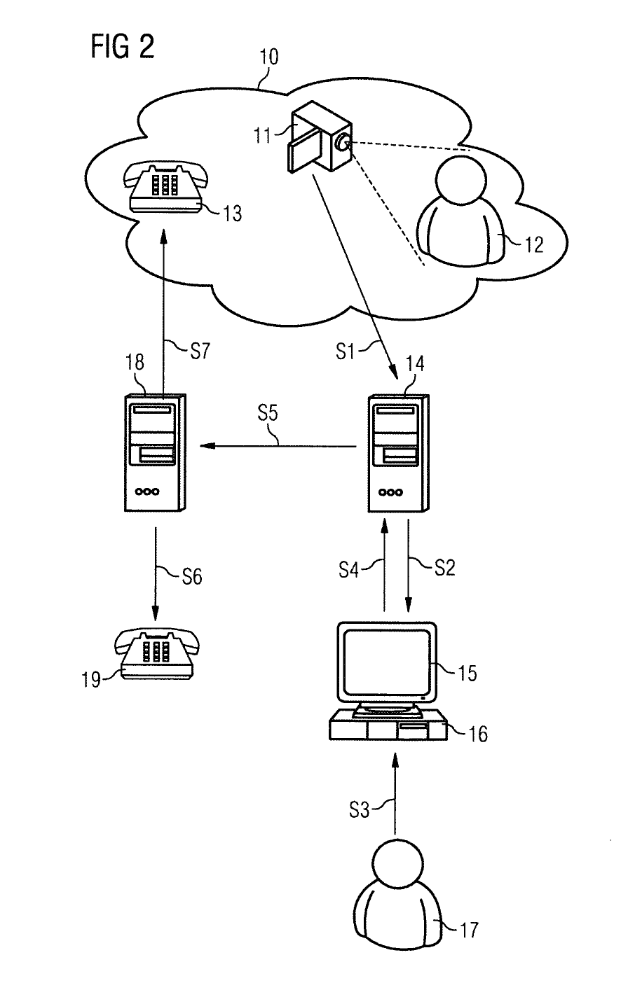

FIG. 2 shows the sequence for setting up a communication connection between the viewer and a facility of the program provider. The reference character 10 identifies a television production, in which a television picture is recorded using a camera 11, the television picture being symbolized in the exemplary embodiment by a person identified with the reference character 12. During production of the television program telephone numbers with a keypad coding, as shown in FIG. 1, are superimposed. This superimposition can take place directly into the television picture transmitted to a receiver of the viewer so that even those viewers not receiving the program by way of the internet protocol can select the required telephone numbers. Additional information, in the form of the telephone numbers and the associated keys of the remote control of the set-top box, is transmitted to a computer 14, also referred to as IPTV middleware, in the context of the transmission or broadcasting (S1) of the television program. This transmission can take place for example by a web service implemented before the IPTV middleware.

In S2 the television program is transmitted to the viewer by internet protocol. The telephone numbers and associated keys of the remote control are transmitted to the IPTV set-top box (reference character 16) connected to the receiver 15 in addition to the television picture information. On receipt of the information the software of the IPTV set-top box can associate the keys of the remote control with a telephone number.

A viewer 17 watches the program and wants for example to select a superimposed telephone number or vote for one of the options shown in the television program. To this end the viewer actuates one of the keys symbolized in the television picture on the remote control of the IPTV set-top box, e.g. one of the color-coded keys red, green, yellow or blue.

It is assumed in the exemplary embodiment that the set-top box 16 of the viewer does not have its own communication apparatus, with which a communication connection to a communication device 13, e.g. a telephone server, of the television production 10, can be established directly. A communication connection is therefore established by way of the IPTV middleware 14 of the IPTV provider. When one of the color-coded keys of the remote control is pressed, the IPTV set-top box 16 sends a message to the IPTV middleware 14 of the IPTV provider. This is symbolized by S4. In addition to the identification of the IPTV set-top box the message contains information about the selected program and the selected color key or the telephone number to be selected directly.

The IPTV middleware establishes a communication connection to a computer 18, a telephony switching server. Either the IPTV provider or the viewer has an account with this computer 18. This allows the costs of setting up the communication connection to be billed to the viewer. Transmission of the data from the IPTV middleware 14 to the computer 18 is identified by S5.

Once the IPTV middleware 14 has been connected to the telephony switching server 18, the provider establishes a communication connection, in the exemplary embodiment a telephone connection, between the viewer (communication terminal 19) and the program provider (communication device 13). In this process the connection between the computer 18 and the communication device 19 is established (S6) first and then the connection between the computer 18 and the communication device 13 is established (S7).

The described method means that when watching television by way of the internet a viewer no longer needs to dial a telephone number displayed in a television picture by way of a communication terminal, such as a telephone for example. Instead the method allows the viewer to select the telephone number by pressing a key on the remote control of the IPTV set-top box. This has a number of advantages: the viewer no longer has to key in the telephone number and is instead encouraged to contact a telephone number superimposed on the television picture. The IPTV provider can bill the service as part of a charging system (micro payment) or charge for the activation of the service. The provider of the television program will achieve higher sales with such superimposed numbers due to the simpler option they offer and the lower level of inhibition in respect of selecting a telephone number superimposed on a television program.

Reference is also made to the method described in FIG. 2 in the further description. The following assumptions are also made for the exemplary embodiment below:
The television program is to be a live broadcast.
A communication apparatus (IP telephony client) is installed on the IPTV set-top box 16 of the viewer 17, which is able to establish a communication connection between the provider of the television program and the viewer directly.

At first, the provider of the television program sends the information relating to the telephone numbers to be superimposed and the keys to be selected to the IPTV provider by way of a content management interface. The information can be sent in the form of an XML message for example, which can have the format shown below for example. XML stands for Extendable Markup Language.

```
<click-to-dial-info>
    <!-- content-provider identifies the IPTV program provider uniquely for the IPTV provider-->
    <content-provider=“an iptv provider”/>
    <!- iptv program identifies the IPTV program, regardless of transmission time or IPTV transmission
        channel.
        The transmission time is determined by the IPTV provider, when isLive is false. The transmission channel is
        only determined by the IPTV provider.-->
      <iptv program id=″a tv program″ isLive=″true″>
      <!-description of key assignment, can contain a number of dial info tags-->
      <dial-info>
          <!-validity defines the validity of the telephone numbers.
              Validity can be specified absolutely or relative to the program start or as “variable”.
              If variable the IPTV provider must send an additional message to activate key allocation -->
          <validity type = “absolute”>
              <!- start and end can be specified as long value or as data character sequence-->
              <absolute start= “15.03.2007 18:45:20” end= “15.03.2007 18:45:35”/>
          </validity>
          <key allocation>
            <!-here the keys red, blue, yellow and green are allocated to different telephone numbers.
                id identifies the key to be allocated uniquely.
                telephone number specifies the linked telephone number -->
            <keyid= “red” telephone number==″01805-555-555-555I7>
            <keyid= “blue” telephone number=″01805-555-555-556′7>
            <keyid= “yellow” telephone number=″01805-555-555-557′7>
            <keyid- “green” telephone number=″01805-555-555-558”/>
          <key allocation>
    </dial-info>
</click-to-dial-info>
```

Second, the information contained in the message is transmitted by IP multicast to the IPTV set-top boxes of the viewers. IP multicast is an IP protocol for the simultaneous bandwidth-saving transmission of data to a plurality of receivers (viewers). It is standard here for IPTV middleware to provide a multicast transmission channel for the transmission of program information. The IPTV set-top box stores the information. If the viewer has selected the specified IPTV channel at the specified times, key allocation is activated, i.e. switched on. When a different IPTV channel is selected, the key allocation is withdrawn again.

Third, the viewer has selected the specified channel at the specified time and presses one of the configured keys of the remote control. In contrast to the solution described in conjunction with FIG. 2 in the exemplary embodiment a communication apparatus is installed on or in the IPTV set-top box itself. This can be configured in the form of hardware or software. When the key is pressed, the IPTV set-top box triggers the IPTV telephony client to set up a connection from the IPTV telephony client to the specified telephone number. In contrast to the solution outlined above there is no further communication between the IPTV set-top box and the IPTV middleware.

Thus, a communication connection is established between the IP telephony client of the set-top box and the specified telephone number, i.e. the communication device associated with the telephone number, with corresponding charging.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-18. (canceled)

19. A data processing device, connected to a receiver and a communication network, capable of receiving a code from an input apparatus of the data processing device and/or the receiver, comprising:
a first component receiving and processing data, sent from the communication network, including data and at least one item of identification data, and transmitting processed data to the receiver for output;
a second component receiving and processing a code sent from the input apparatus of the data processing device and/or the receiver, the code being associated with an identification data item of the identification data; and
a communication unit, establishing, in response to receipt of the code, a communication connection between the data processing device or a communication terminal and a facility of the communication network with which the identification data item is associated.

20. The data processing device as claimed in claim 19, further comprising a processor determining, the identification data item and selection information corresponding to an input element of the input apparatus and associated with the identification data item, from the data sent from the communication network, and determining the code associated with the identification data item from the selection information.

21. The data processing device as claimed in claim 20, wherein the first component transmits the at least one identification data item and the associated selection information to the receiver to be output.

22. The data processing device as claimed in claim 21, wherein the code is associated with the input element of the input apparatus and is sent out by the input apparatus upon actuation of the input element.

23. The data processing device as claimed in claim 22, further comprising a storage unit storing the identification data item and the code associated with the identification data item.

24. The data processing device as claimed in claim 23, wherein the communication unit establishes the communication connection directly to the facility of the communication network.

25. The data processing device as claimed in claim 23, wherein the communication unit transmits a message to a communication apparatus in the communication network to establish a communication connection with the facility of the communication network, the message including an identifier of the data processing device, information concerning the data transmitted to the receiver, information concerning the selection information or the identification data item, which is associated with the selection information, thereby enabling the communication apparatus to establish a communication connection between the data processing device and the facility of the communication network.

26. The data processing device as claimed in claim 25, wherein the first component receives data based on the internet protocol.

27. The data processing device as claimed in claim 26, wherein the communication connection is set up to the facility of the communication network only when the code is received, if the data sent from the communication network and received by the data processing device, comprising the at least one identification data item and the respectively associated selection information, is transmitted to the receiver.

28. An input apparatus, as a remote control controlling a data processing device connected to a communication network having a facility, comprising:
at least one input element;
a monitor monitoring actuation of the at least one input element; and
a transmitter, coupled to the monitor, sending, in response to actuation of the at least one input element, a unique code associated with the at least one input element, where the data processing device, upon receipt of the unique code, initiates setting up a communication connection to a facility of the communication network associated with an identification data item associated with the unique code.

29. A method for operating a data processing device as a set-top box connected to a receiver and a communication network, comprising:
receiving and processing data sent from the communication network to the data processing device, the data including content data and identification data;
transmitting the data after said processing to the receiver to be output;
receiving and processing a code sent from an input apparatus of the data processing device and/or the receiver, the code being associated with an identification data item of the identification data; and
establishing, in response to receipt of the code, a communication connection between the data processing device or a communication terminal and a facility of the communication network with which the identification data item is associated

30. The method as claimed in claim 29, wherein the data processing device determines at least one identification data item and selection information corresponding to an input element of the input apparatus and associated with the identification data item based on the data received from the communication network.

31. The method as claimed in claim 30, wherein the data processing device determines the code associated with the identification data from the selection information.

32. The method as claimed in claim 31, wherein the identification data item and the selection information associated therewith are stored in the data processing device.

33. The method as claimed in claim 32, wherein said establishing establishes a communication connection directly with the facility of the communication network.

34. The method as claimed in claim 32, wherein said establishing comprises
transmitting a message to a communication apparatus of the communication network, the message including an identifier of the data processing device, information concerning the data transmitted to the receiver, and information concerning the selection information or the identification data item associated with the selection information; and
establishing, by the communication apparatus of the communication network, a communication connection to the facility of the communication network, based on the message.

35. The method as claimed in claim 34, wherein the data is transmitted from the communication network to the data processing device according to an internet protocol.

36. A method for providing an interaction channel in a television program, comprising:
providing data to be output on a receiver, the data including content data, at least one identification data item and respective selection information associated with the at least one identification data item;
transmitting the data to a data processing device for processing and forwarding to a receiver connected to the data processing device;
transmitting the at least one identification data item and the respective selection information to a communication apparatus of a communication network; and
establishing a communication connection, when the communication apparatus receives a message sent from the data processing device, from which a specific identification data item of the identification data can be determined, the communication connection being established between a facility, with which the specific identification data item is associated, and a communication terminal of a viewer of the television program.
